(19) United States
(12) Patent Application Publication
(10) Pub. No.: US 2014/0365250 A1
(43) Pub. Date: Dec. 11, 2014

(54) TRANSPORTATION SERVICE RESERVATION METHOD AND APPARATUS

(71) Applicants: FUJITSU LIMITED, Kawasaki-shi (JP); Massachusetts Institute of Technology, Cambridge, MA (US)

(72) Inventors: Takuro IKEDA, Yokohama (JP); Moshe E. Ben-Akiva, Brookline, MA (US)

(73) Assignees: FUJITSU LIMITED, Kawasaki-shi (JP); Massachusetts Institute of Technology, Cambridge, MA (US)

(21) Appl. No.: 14/259,315

(22) Filed: Apr. 23, 2014

Related U.S. Application Data
(60) Provisional application No. 61/831,354, filed on Jun. 5, 2013.

(51) Int. Cl. G06Q 50/30; G06Q 10/02

(52) U.S. Cl. CPC G06Q 50/30; G06Q 10/02
USPC 705/5

(57) ABSTRACT

A transportation service reservation method includes receiving a ride request specifying an origin and a destination; with respect to each of vehicles each capable of providing ride options in multiple forms of ride, generating a feasible ride option pertaining to the multiple forms of ride by referring to a storage part storing information indicating schedules assigned to the vehicle and forms of ride of the schedules; calculating a choice probability of each of ride options forming a subset with respect to each of one or more subsets satisfying a predetermined condition among subsets of a group of the generated feasible ride options; and selecting a subset to be offered in response to the ride request from among the one or more subsets satisfying the predetermined condition, based on the calculated choice probabilities. The receiving, generating, calculating, and selecting are executed by a computer.

### CROSS-REFERENCE TO RELATED APPLICATION

This application is based upon and claims the benefit of priority of the prior U.S. Provisional Application No. 61/831,354, filed on Jun. 5, 2013, the entire contents of which are incorporated herein by reference.

### FIELD

A certain aspect of the embodiments discussed herein is related to a transportation service reservation method and apparatus.

### BACKGROUND

Systems have been devised for reserving a taxi using a mobile device. (See, for example, https://hailocab.com/ and https://www.uber.com/, both retrieved on Nov. 18, 2013.) A GPS (Global Positioning System)-equipped mobile device transmits a request for a ride (a ride request) including information on a user's current location to a server in response to an instruction from the user. The server, for example, assigns the ride request to a vehicle that can pick up the user earliest and notifies the mobile device of a scheduled pickup time. The reservation is finalized when the user's acceptance notice is transmitted from the mobile device to the server. It is not economical, however, to use taxis on a daily basis because taxi fares are high.

Therefore, systems have been devised for finding matches for requests for ridesharing that is available at relatively low cost. (See, for example, http://www.lyft.me/ and http://www.side.cr/, both retrieved on Nov. 18, 2013.) A user transmits a ride request, specifying conditions such as an origin, a destination, a preferred departure time, and a preferred arrival time, to a server. The server retrieves other people seeking for ridesharing pertaining to other ride requests that are similar to the transmitted ride request in terms of time and space, or retrieves people who offer rides, and presents the user with the retrieval results as candidates to share a ride with. When a notice of acceptance is transmitted from the user, the reservation is finalized. Forms of ridesharing include providing door-to-door transportation and picking up and dropping off people at predetermined locations such as bus stops.

### SUMMARY

According to an aspect of the embodiments, a transportation service reservation method includes receiving a ride request specifying an origin and a destination; with respect to each of vehicles each capable of providing ride options in multiple forms of ride, generating a feasible ride option pertaining to the multiple forms of ride by referring to a storage part storing information indicating schedules assigned to the vehicle and forms of ride of the schedules; calculating a choice probability of each of ride options forming a subset with respect to each of one or more subsets satisfying a predetermined condition among subsets of a group of the generated feasible ride options; and selecting a subset to be offered in response to the ride request from among the one or more subsets satisfying the predetermined condition, based on the calculated choice probabilities. The receiving, generating, calculating, and selecting are executed by a computer.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a diagram illustrating a configuration of a transportation service reservation system according to a first embodiment;

FIG. 2 is a diagram illustrating a hardware configuration of a transportation service reservation apparatus according to the first embodiment;

FIG. 3 is a diagram illustrating a functional configuration of a transportation service reservation system according to the first embodiment;

FIG. 4 is a diagram for illustrating a procedure for a process for reserving a transportation service;

FIG. 5 is a diagram illustrating schedule information stored in a schedule information storage part;

FIG. 6 is a diagram illustrating the behavior of a vehicle obtained from schedule information;

FIG. 7 is a diagram illustrating a configuration of a reservation information storage part;

FIG. 8 is a flowchart for illustrating a procedure for a process for generating ride options and selecting ride options to be offered to a user;

FIG. 9 is a flowchart for illustrating a procedure for a process for generating feasible ride options;

FIG. 10 is a diagram illustrating a first example of the updating of schedule information;

FIG. 11 is a diagram illustrating a second example of the updating of schedule information;

FIG. 12 is a diagram illustrating information obtained by a process for generating feasible ride options;

FIG. 13 is a diagram illustrating a configuration of a transportation service reservation system according to a second embodiment; and

FIG. 14 is a diagram illustrating a functional configuration of a transportation service reservation system according to the second embodiment.

### DESCRIPTION OF EMBODIMENTS

As described above, systems have been devised for rideshare matching. These systems, however, merely enumerate options that match the conditions specified in a user's ride request, and do not take into consideration economic effects such as an increase in the profit of a service provider or an increase in users' satisfaction.

According to an aspect of the embodiments, it is possible to offer ride options that are likely to improve economic effects.

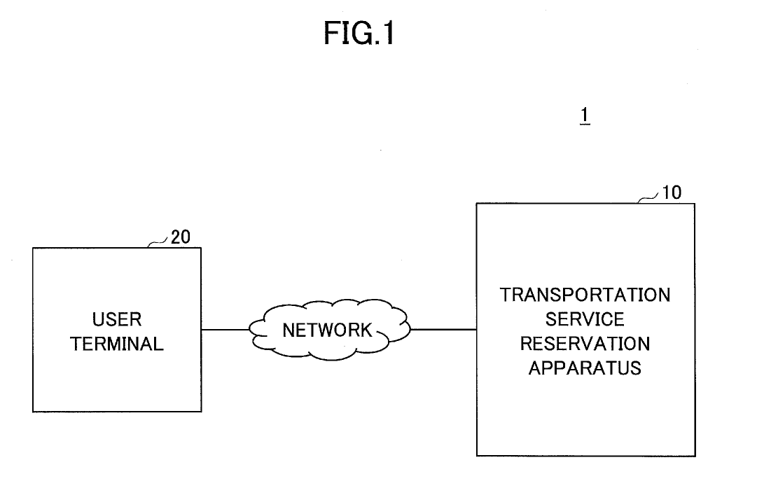

Preferred embodiments of the present invention will be explained below with reference to accompanying drawings. FIG. 1 is a diagram illustrating a configuration of a transportation service reservation system according to a first embodiment. Referring to FIG. 1, a transportation service reservation system 1 includes a transportation service reservation apparatus 10 and at least one user terminal 20. The transportation service reservation apparatus 10 and the user terminal 20 are connected via a communications network such as the Internet or a telephone line so as to be able to communicate with each other.

The transportation service reservation apparatus 10 is a computer that accepts a ride request for a transportation service and executes a process for generating a ride option according to the ride request. The transportation service refers to a service to transport a user to a destination by a vehicle such as an automobile. The transportation service reservation apparatus 10 may be, for example, a computer used in a company that provides a transportation service.

According to the transportation service of this embodiment, services of multiple forms of ride may be provided by a single vehicle. Examples of services of multiple forms of ride include a taxi service, a shared taxi service, and a mini-bus service.

The taxi service refers to a service to provide door-to-door transportation in response to a single request for a ride (a single ride request). The term “door-to-door” means, for example, going from an origin to a destination as specified by a user. Accordingly, a user may be picked up and dropped off at any locations. Furthermore, being “in response to a single ride request” means, for example, that the number of ride requests that may be served by a single vehicle or that may be simultaneously assigned to a single vehicle with respect to the taxi service is one.

The shared taxi service refers to a service that provides door-to-door transportation like the taxi service but is able to serve multiple ride requests. Being “able to serve multiple ride requests” means that the number of ride requests that may be served by a single vehicle or that may be simultaneously assigned to a single vehicle with respect to the shared taxi service is one or more. Accordingly, in the case of the shared taxi service, strangers may ride together. Furthermore, a vehicle makes a detour to pick up and drop off other people to share a ride with, so that the travel time of each passenger may increase compared with the taxi service.

The mini-bus service refers to a service that is able to serve multiple ride requests but has a vehicle run on a predetermined route. Passengers are picked up and dropped off at bus stops or any locations on the route. Accordingly, with respect to the mini-bus service, the travel time of each passenger is less likely to increase because of other people to share a ride with. Each passenger, however, needs to travel between a pickup/drop-off location and an origin or a destination. Unlike typical fixed route buses, the mini-bus service has no predetermined timetable. When the mini-bus service is assigned to a vehicle, the mini-bus service is provided by the vehicle.

The transportation service reservation system 1 of this embodiment dynamically allocates a single vehicle to one of the taxi service, the shared taxi service, and the mini-bus service. Therefore, vehicles of a riding capacity of, for example, approximately six to approximately eight people may be used. Furthermore, different fares may be set for the taxi service, the shared taxi service, and the mini-bus service even when the same vehicle is used with the same origin and the same destination.

The concept that distinguishes the taxi service, the shared taxi service, and the mini-bus service is hereinafter referred to as “service type.”

The user terminal 20 is a terminal used by a user of a transportation service. That is, the user terminal 20 serves as an input/output interface to a user with respect to a transportation service. Examples of the user terminal 20 include feature phones, smartphones, tablet terminals and personal computer (PC)s.

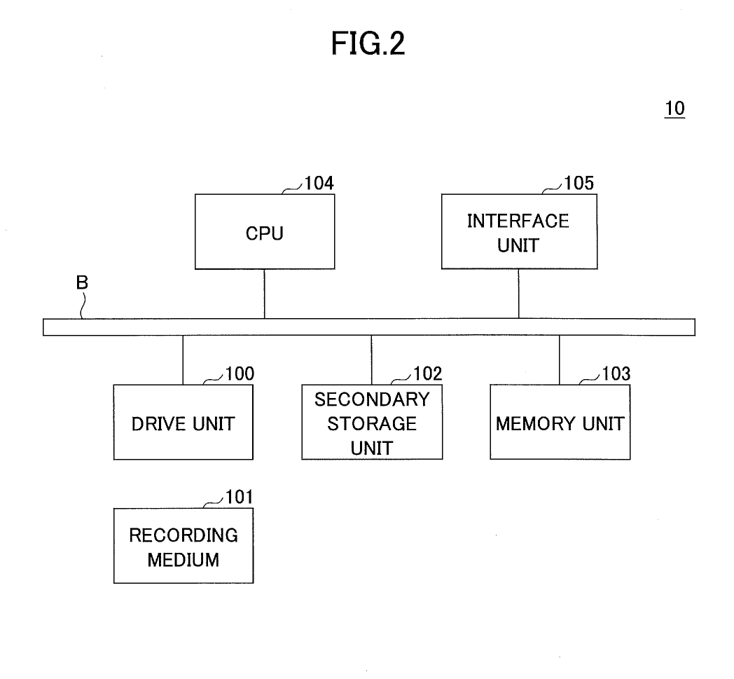

FIG. 2 is a diagram illustrating a hardware configuration of a transportation service reservation apparatus according to the first embodiment. Referring to FIG. 2, the transportation service reservation apparatus 10 includes a drive unit 100, a secondary storage unit 102, a memory unit 103, a central processing unit (CPU) 104, and an interface unit 105, all of which are interconnected by a bus B.

A program that implements a process in the transportation service reservation apparatus 10 is provided by a recording medium 101. When the recording medium 101 in which a program is recorded is loaded into the drive unit 100, the program is installed in the secondary storage unit 102 from the recording medium 101 via the drive unit 100. The program, however, does not have to be installed from the recording medium 100 and may be downloaded from another computer via a network. The secondary storage unit 102 stores the installed program as well as files and data.

In response to an instruction to start a program, the memory unit 103 reads the program from the secondary storage unit 102 and stores the read program. The CPU 104 executes functions pertaining to the transportation service reservation apparatus 10 in accordance with the program stored in the memory unit 103. The interface unit 105 is used as an interface for connecting to a network.

Examples of the recording medium 101 include portable recording media such as a CD-ROM, a DVD disk, and a USB memory. Furthermore, examples of the secondary storage unit 102 include a hard disk drive (HDD) and a flash memory. Each of the recording medium 101 and the secondary storage unit 102 corresponds to a computer-readable recording medium.

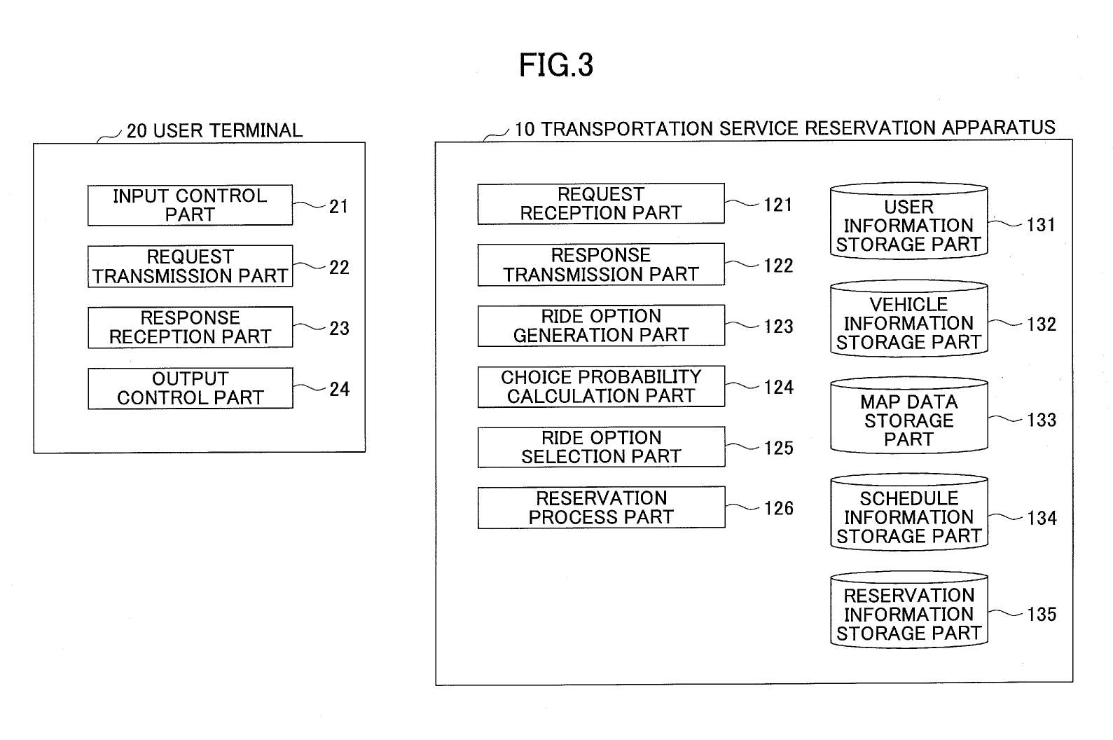

FIG. 3 is a diagram illustrating a functional configuration of a transportation service reservation system according to the first embodiment. Referring to FIG. 3, the user terminal 20 includes an input control part 21, a request transmission part 22, a response reception part 23, and an output control part 24. These parts 21 through 24 may be implemented by a process that a program installed in the user terminal 20 causes a CPU of the user terminal 20 to execute.

The input control part 21 receives an instruction input by a user. The request transmission part 22 transmits a request according to the user's instruction to the transportation service reservation apparatus 10. According to this embodiment, a request to use a transportation service (hereinafter referred to as “request for a ride” or “ride request”) is transmitted. The response reception part 23 receives a response to the request transmitted by the request transmission part 22. The output control part 24 causes information included in the response received by the response reception part 23 to be displayed on a display unit of the user terminal 20.

The transportation service reservation apparatus 10 includes a request reception part 121, a response transmission part 122, a ride option generation part 123, a choice probability calculation part 124, a ride option selection part 125, and a reservation process part 126. These parts 121 through 126 are implemented by a process that a program installed in the transportation service reservation apparatus 10 causes the CPU 104 to execute. The transportation service reservation apparatus 10 further includes a user information storage part 131, a vehicle information storage part 132, a map data storage part 133, a schedule information storage part 134, and a reservation information storage part 135. These storage parts 131 through 135 may be implemented using the secondary storage unit 102 (FIG. 2), for example. Alternatively, these storage parts 131 through 135 may be implemented using a storage unit connected to the transportation service reservation apparatus 10 via a network.

The request reception part 121 receives a ride request. The ride request includes conditions specified with respect to a ride, such as a user ID, which is information identifying a user, a ride date, an origin, and a destination.

The ride option generation part 123 generates feasible ride options with respect to each vehicle and each form of ride based on the ride request, referring to schedules stored in the schedule information storage part 134.

A schedule is information indicating an operation procedure in the case of executing a service, and includes information such as a stop location list, an arrival time and a departure time at each stop location, and passengers to pick up and drop off at each stop location.

A ride option is information indicating the contents of a service provided to each user, and includes information such as a service type, a pickup location, a drop-off location, a scheduled pickup time, a scheduled drop-off time, and a fare.

The generation of a ride option refers to generating a new schedule or updating an existing schedule for a vehicle in response to a ride request and determining the contents of a service to a user who has made the ride request based on the schedule.

The choice probability calculation part 124 calculates the choice probability of each of the ride options of a subset with respect to each of subsets satisfying a predetermined condition or a predetermined rule (hereinafter collectively referred to as “predetermined condition”) among the subsets of a group of ride options generated by the ride option generation part 123. The choice probability refers to the probability of an individual ride request being chosen by a user. The predetermined condition is, for example, the condition that the elements of a subset are three ride options that are different in service type from one another. In this case, one ride option pertaining to the taxi service, one ride option pertaining to the shared taxi service, and one ride option pertaining to the mini-bus service constitute a subset that satisfies a predetermined condition. The predetermined condition, however, may be suitably changed in accordance with a policy such as what ride options are to be offered to a user. For example, one subset may include two ride options with respect to each service type.

The ride option selection part 125 selects a combination of ride options to be offered to a user from among the subsets (combinations of ride options) that satisfy a predetermined condition, based on the calculated choice probabilities. For example, the ride option selection part 125 selects, based on the choice probabilities, a combination of ride options that maximizes the representative utility of a user (hereinafter simply referred to as “utility”) or the profit of a service provider.

The response transmission part 122 returns the information of each of the ride options of the combination of ride options determined by the ride option selection part 125 as a response to the ride request. When a ride option is selected in the user terminal 20 based on the information returned by the response transmission part 122, a request to reserve a ride option (a ride option reservation request) including the result of the selection of a ride option is received by the request reception part 121.

In response to the ride option reservation request, the reservation process part 126 stores information regarding the reserved ride option in the reservation information storage part 135, and stores information regarding the schedule of the reserved ride option in the schedule information storage part 134.

The reservation information storage part 135 stores information regarding the reserved ride option.

The user information storage part 131 stores information on each user. The information includes, for example, a user ID, age, and a gender.

The vehicle information storage part 132 stores information on each vehicle. The information includes, for example, a vehicle type, a riding capacity, and the current location information of a vehicle.

The map data storage part 13 stores information regarding a road network (road network information). The road network information is expressed as, for example, a network formed of nodes and links, and includes the latitudes and longitudes of crossings and various points of interest (POI), the lengths and widths of roads, the presence or absence of traffic signals, and traffic regulation information. Furthermore, the road network information may also include real-time road traffic information obtained using various kinds of sensors. The road traffic information may include, for example, a time required to drive through a road with respect to each road.

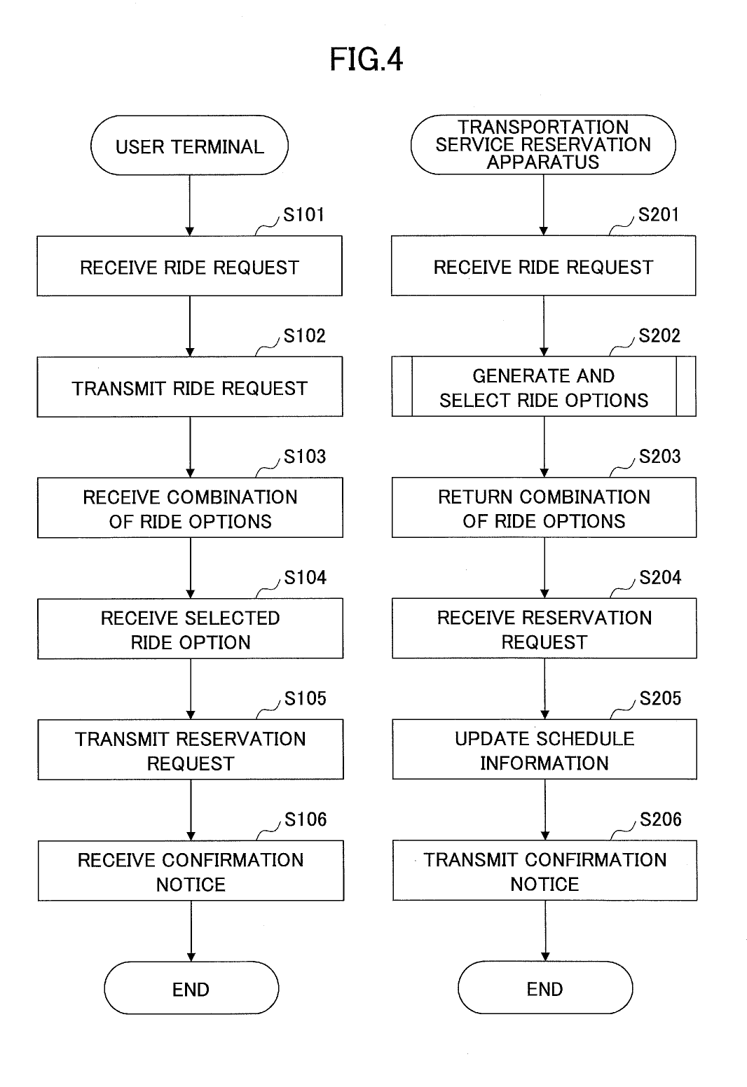

A description is given below of a procedure for a process executed by the user terminal 20 and the transportation service reservation apparatus 10. FIG. 4 is a diagram for illustrating a procedure for a process for reserving a transportation service (a transportation service reservation process).

Referring to FIG. 4 as well as FIG. 2 and FIG. 3, at step S101, the input control part 21 of the user terminal 20 receives a group of parameters related to a ride request input from a user. The group of parameters includes information indicating a user ID, a ride date, an origin, and a destination. Furthermore, the group of parameters may include at least one of a preferred departure time and a preferred arrival time. Furthermore, the group of parameters may also include the number of passengers or the number of seats. In the case of specifying a preferred departure time and/or a preferred arrival time, a specific time such as “8:00” may be specified or the time may be specified by a time period such as “8:00 to 8:30.” Furthermore, the preferred departure time may be specified in such form as “immediately”, that is, “as soon as possible.”

Next, at step S102, the request transmission part 22 of the user terminal 20 transmits a ride request including the input parameters to the transportation service reservation apparatus 10. At step S201, the ride request is received by the request reception part 121 of the transportation service reservation apparatus 10.

Next, at step S202, in response to the ride request, the transportation service reservation apparatus 10 executes a process for generating ride options and selecting a ride option to be offered to a user, referring to the schedule information storage part 134.

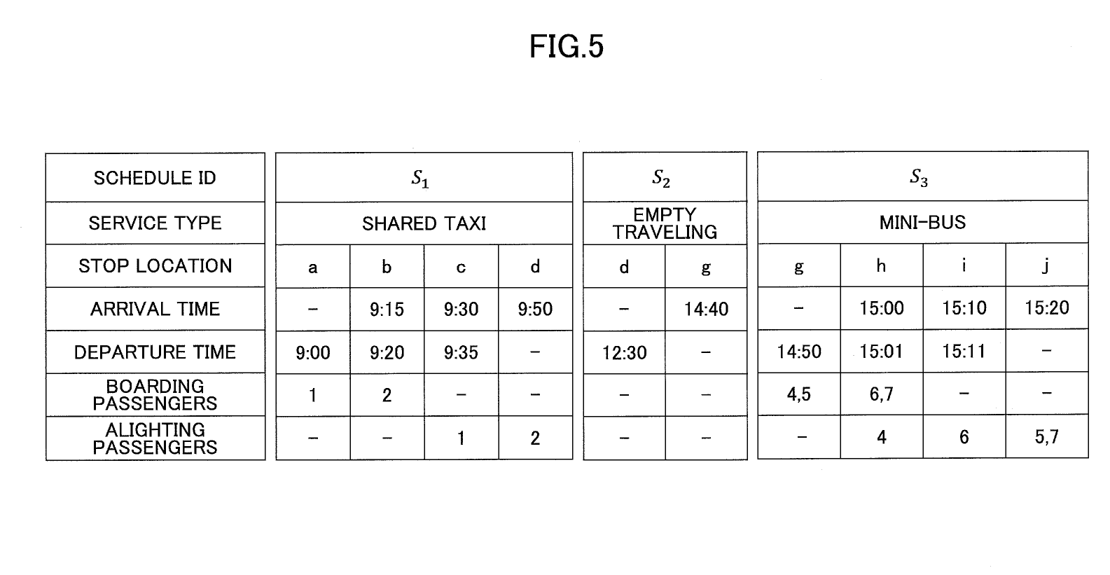

FIG. 5 is a diagram illustrating schedule information stored in a schedule information storage part. FIG. 5 illustrates the schedule information of a vehicle for one day. In FIG. 5, each block (each rectangle) corresponds to one schedule.

Referring to FIG. 5, subsequently to a schedule of the shared taxi service, a schedule of the mini-bus service is assigned to the vehicle. That is, time progresses in the rightward direction (from left to right) in FIG. 5.

A schedule of traveling empty (without passengers) from the last drop-off location of the shared taxi service to the first pickup location of the mini-bus service (hereinafter, “empty travel schedule”) is inserted between the shared taxi service and the mini-bus service. Each schedule includes information such as a schedule ID, a service type, a stop location, an arrival time, a departure time, a boarding (pickup) passenger list, and an alighting (drop-off) passenger list.

The schedule ID is information identifying an individual schedule. The service type is the service type of an individual schedule. The service type of the empty travel schedule is determined as “empty travel.” The stop location is information identifying a stop location, such as a location name, an address, a latitude, and a longitude.

The arrival time is a time of arrival at a stop location. The departure time is a time of departure from a stop location. The boarding passenger list is a list of the user IDs of users who are picked up at stop locations. The alighting passenger list is a list of the user IDs of users who are dropped off at stop locations.

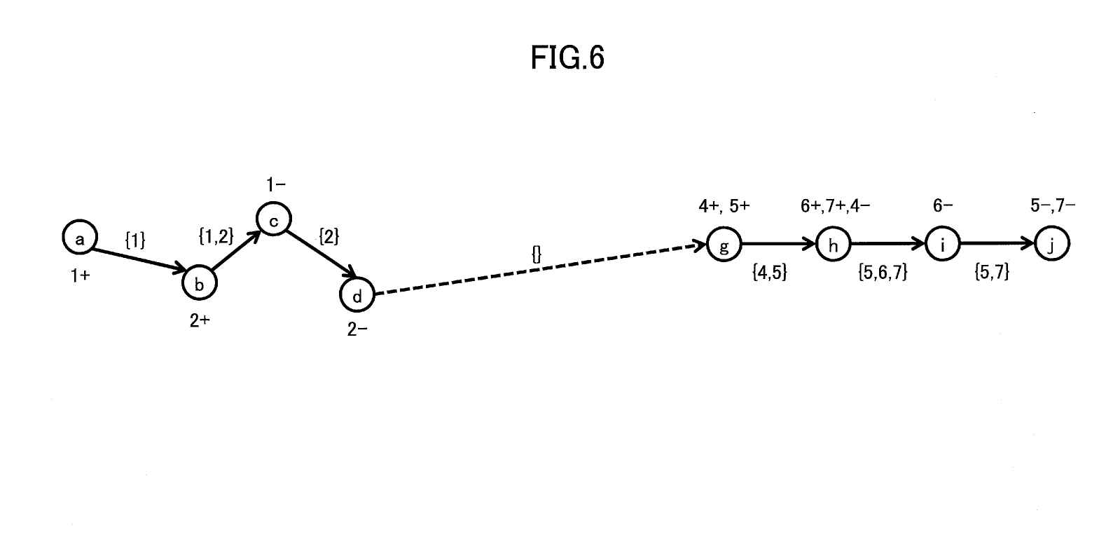

FIG. 6 is a diagram illustrating the behavior of a vehicle obtained from schedule information. FIG. 6 illustrates the behavior of a vehicle obtained from the schedule information illustrated in FIG. 5 in a directed graph.

Each node of the directed graph indicates a stop location. The alphabetical letters inside the nodes coincide with the stop location values of FIG. 5. A number appended to each node indicates the user ID of a user who is picked up or dropped off at a stop location pertaining to the node. A number with a plus sign indicates the user ID of a user who is picked up, and a number with a minus sign indicates the user ID of a user who is dropped off. A number in curly brackets provided to a directional branch is the user ID of a user transported between the two stop locations connected by the directional branch.

In the process for generating ride options, in order to achieve a service responding to the ride request, a new schedule is generated or an existing schedule is updated, and a ride option is generated based on the schedule. The scheduled pickup time and the scheduled drop-off time of a ride option may differ from vehicle to vehicle depending on the availability, that is, reservation status, of a vehicle and the current location of a vehicle. Furthermore, in the case of the mini-bus service, the pickup location and the drop-off location may differ depending on the route of a vehicle assigned the mini-bus service.

In the process for selecting a ride option to be offered to a user, the choice probability of each of the ride options of a subset (a combination of ride options) is calculated with respect to each of subsets satisfying a predetermined condition among the subsets of a group of generated ride options. A combination of ride options to be offered to a user is selected from among the subsets that satisfy a predetermined condition, based on the calculated choice probabilities.

Next, at step S203, the response transmission part 122 of the transportation service reservation apparatus 10 returns information regarding each of the ride options of the selected combination to the user terminal 20 that is a transmitter of the ride request. The information regarding each of the ride options includes, for example, a service type, a pickup location, a drop-off location, a scheduled pickup time, a scheduled drop-off time, and a fare.

At step S103, the returned information is received by the response reception part 23 of the user terminal 20. The output control part 24 of the user terminal 20 displays the ride options included in the received information as options (choices or alternatives). The user determines a ride option that the user wishes to use by comparing the service types, pickup locations, drop-off locations, scheduled pickup times, scheduled drop-off times, and fares of the ride options.

Next, at step S104, the input control part 21 of the user terminal 20 receives one ride option selected from among the ride options displayed as options. At step S105, in response to the selection of a ride option, the request transmission part 22 transmits, for example, a reservation request including the schedule ID of the selected ride option to the transportation service reservation apparatus 10.

At step S204, the reservation request is received by the request reception part 121 of the transportation service reservation apparatus 10. At step S205, in response to the reception of the reservation request, the reservation process part 126 updates the schedule information stored in the schedule information storage part 134 and adds new schedule information to the reservation information storage part 135. Specifically, the schedule information of a vehicle pertaining to the selected ride option is updated. Furthermore, reservation information pertaining to the reservation request is stored in the reservation information storage part 135.

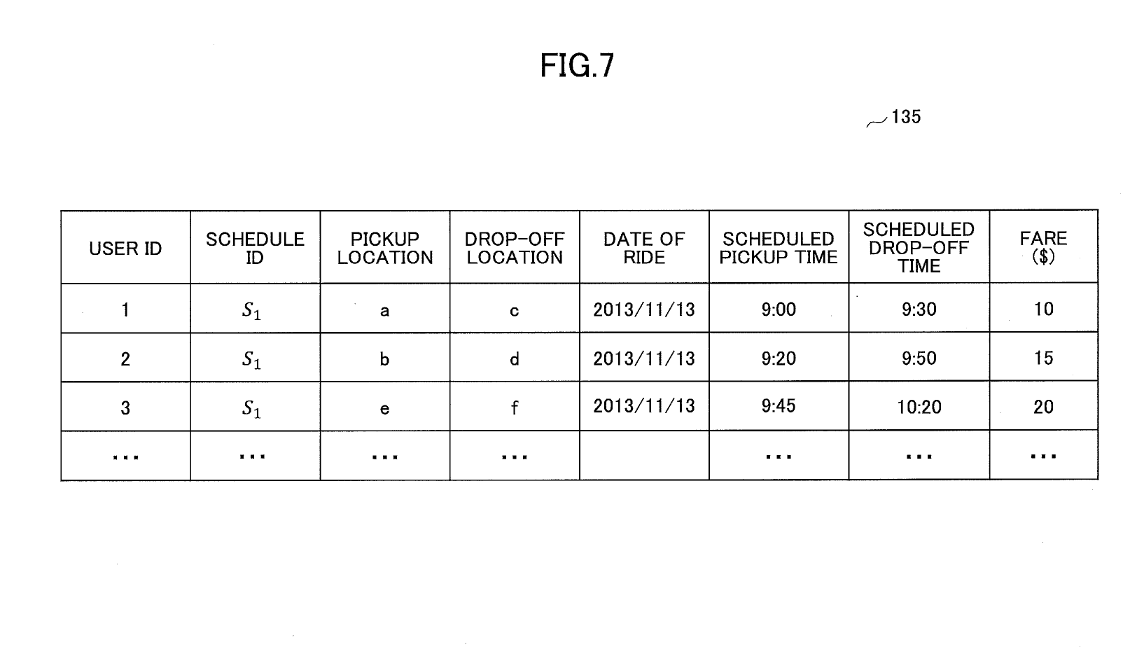

FIG. 7 is a diagram illustrating a configuration of a reservation information storage part. Referring to FIG. 7, the reservation information storage part 135 stores a user ID, a schedule ID, a pickup location, a drop-off location, a scheduled pickup time, a scheduled drop-off time, and a fare with respect to a reserved ride option.

The user ID is the user ID of a user who requests a reservation. The schedule ID is the schedule ID of a schedule correlated with a reserved ride option. The pickup location and the drop-off location are the pickup location and the drop-off location of a ride option. The scheduled pickup time and the scheduled drop-off time are the scheduled pickup time and the scheduled drop-off time of a ride option. The fare is the fare of a ride option. The fare may be calculated based on, for example, a service type and a travel distance.

A description is given below of example updating of schedule information.

Next, at step S206, the response transmission part 122 returns a reservation completion notice to the user terminal 20. At step S106, the response reception part 23 of the user terminal 20 receives the reservation completion notice. The output control part 24 may cause a screen indicating the completion of reservation to be displayed on the user terminal 20.

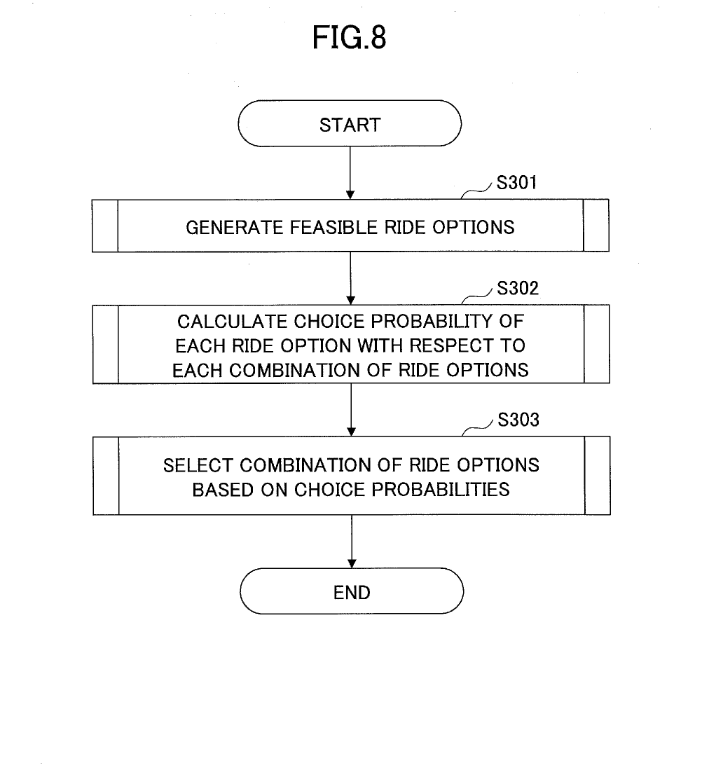

Next, a detailed description is given of step S202. FIG. 8 is a flowchart for illustrating a procedure for a process for generating ride options and selecting ride options to be offered to a user.

Referring to FIG. 8 as well as FIG. 3, at step S301, the ride option generation part 123 generates feasible ride options with respect to each service type with respect to each vehicle based on a ride request from a user and the schedule information of each vehicle.

Next, at step S302, the choice probability calculation part 124 calculates the choice probability of each ride option with respect to each of the combinations of ride options that satisfy a predetermined condition among the subsets (combinations of ride options) of a group of the feasible ride options.

Next, at step S303, the ride option selection part 125 selects a combination of ride options to be offered to a user from among the combinations of ride options satisfying a predetermined condition, based on the choice probabilities calculated by the choice probability calculation part 124.

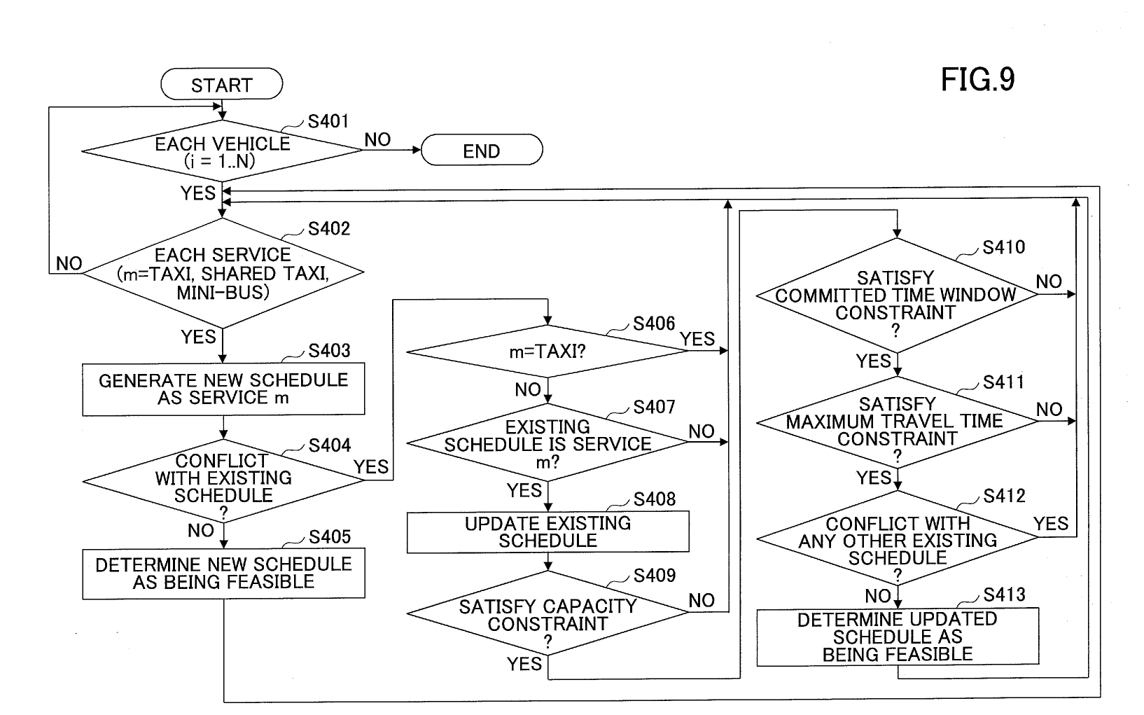

Next, a detailed description is given of step S301. FIG. 9 is a flowchart for illustrating a procedure for a process for generating feasible ride options.

Referring to FIG. 9 as well as FIG. 3, the ride option generation part 123 executes a process at and after step S403 with respect to each vehicle (step S401) and each service type (step S402). In the following, a vehicle that is an object of processing is described as “vehicle i” and a service type that is an object of processing is described as “service m.” The value of i is one of 1 through N, where N is the number of vehicles stored in the vehicle information storage part 132. The value of m is the taxi service, the shared taxi service, or the mini-bus service.

At step S403, the ride option generation part 123 attempts to generate a new schedule pertaining to the service m based on a ride request with respect to the vehicle i.

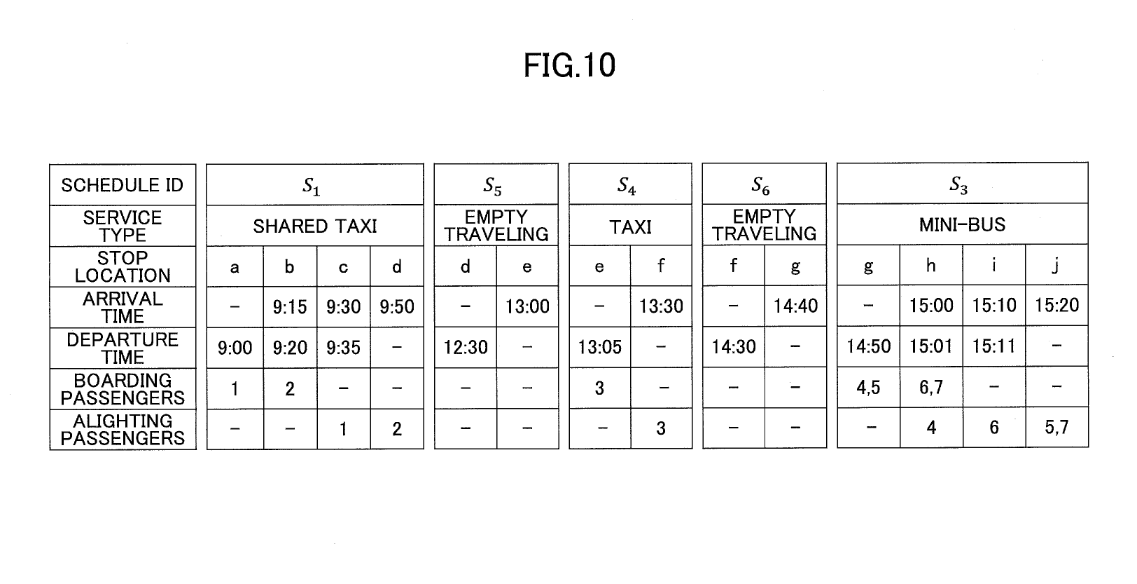

FIG. 10 is a diagram illustrating a first example of the updating of schedule information. FIG. 10 illustrates an example of the updating of the schedule information illustrated in FIG. 5. FIG. 10 illustrates a case where a new schedule S₄ pertaining to the taxi service is inserted between a schedule S₁ pertaining to the shared taxi service and a schedule S₃ pertaining to the mini-bus service of FIG. 5. An empty travel schedule S₅ is inserted between the schedule S₁ and the schedule S₄. Furthermore, an empty travel schedule S₆ is inserted between the schedule S₄ and the schedule S₃. The user ID of a user who uses the new schedule S₄ is “3.”

Here, a ride option obtained from a new schedule does not always have to satisfy all the conditions of a ride request from a user. For example, the scheduled pickup/drop-off time of a ride option obtained from a new schedule may be a predetermined time or less (±α) ahead of or behind the preferred pickup/drop-off time specified by a ride request from a user.

The route search may be performed using, for example, the map data stored in the map data storage part 133 and known techniques.

At step S404, it is determined whether there is a conflict between existing schedules assigned to the vehicle i and the new schedule. Specifically, it is determined whether it is possible to ensure an empty travel time between the new schedule and the existing schedule preceding the new schedule and/or the existing schedule subsequent to the new schedule.

If the new schedule does not conflict with the preceding and/or subsequent existing schedule (NO at step S404), at step S405, the ride option generation part 123 generates a ride option that may be provided to the user based on the new schedule. Specifically, the ride option generation part 123 determines, based on the new schedule, information such as the service type, pickup location, drop-off location, scheduled pickup time, scheduled drop-off time, and fare of a ride option. The new schedule is stored in the memory unit 103. That is, according to the case of FIG. 10, the information of the schedule S₄ is stored in the memory unit 103. At the time of step S405, because the reservation of the new schedule is not confirmed, the new schedule information is not reflected in the schedule information storage part 134.

On the other hand, if the new schedule conflicts with any of the existing schedules (YES at step S404), the ride option generation part 123 determines whether it is possible to provide a service to the ride request by updating the conflicting existing schedule.

First, at step S406, the ride option generation part 123 determines whether the service m is the taxi service. If the service m is the taxi service (YES at step S406), the ride option generation part 123 determines that it is impossible to generate a ride option in the service m with respect to the vehicle i. This is because a ride option with respect to the taxi service is occupied by a single ride request and is accordingly generable only as a new schedule. In this case, the value of the service m is changed and step S402 and the subsequent steps are executed.

If the service m is other than the taxi service (NO at step S406), at step S407, the ride option generation part 123 determines whether the conflicting existing service is the service m. If the conflicting existing service is different from the service m (NO at step S407), the ride option generation part 123 determines that it is impossible to generate a ride option in the service m with respect to the vehicle i. This is because a single vehicle cannot simultaneously provide different services. In this case, the value of the service m is changed and step S402 and the subsequent steps are executed.

If the conflicting existing service is the service m (YES at step S407), at step S408, the ride option generation part 123 updates the conflicting existing schedule.

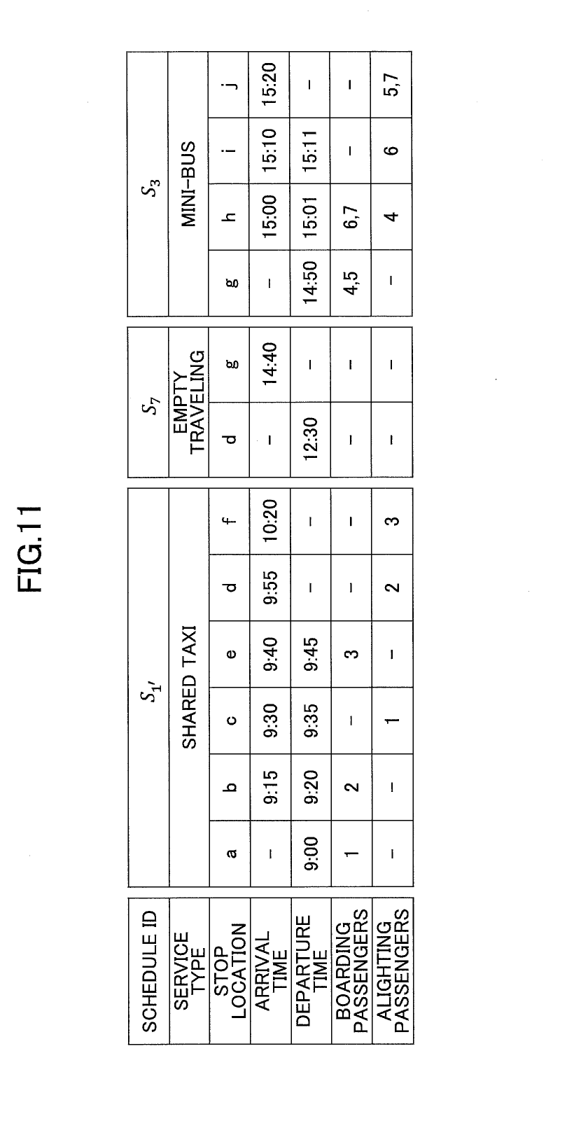

FIG. 11 is a diagram illustrating a second example of the updating of schedule information. FIG. 11 illustrates an example of the updating of the schedule information illustrated in FIG. 5. Referring to FIG. 11, the existing schedule S₁ pertaining to the shared taxi service is updated to a schedule S₁′. That is, FIG. 11 is a case where the transportation of a user pertaining to a new ride request is provided by updating an existing schedule.

Specifically, the result of inserting the columns of two stop locations (stop location e and stop location f) corresponding to the origin and the destination specified in the ride request into the existing schedule S₁ is determined as the schedule S₁′. Furthermore, the arrival time and the departure time are updated with respect to the stop locations subsequent to the inserted stop locations. This is because the addition of stop locations means the insertion of a new route in an existing schedule, thus taking time for traveling the new route. The method of inserting stop locations corresponding to a ride request into an existing schedule depends on a scheduling and routing algorithm. The order of picking up and dropping off passengers may be determined so as to minimize the total travel distance. Furthermore, a new route generated by the addition of stop locations and the time taken for the new route may be calculated using known route search techniques. In FIG. 11, the user ID of a user who is picked up and dropped off at the added stop locations, that is, a user pertaining to the ride request based on which the schedule has been updated, is “3.”

It is the working copy of the schedule information of the vehicle i, copied from the schedule information storage part 134 to, for example, the memory unit 103, that is updated at step S408.

Next, it is determined whether the updated existing schedule (hereinafter referred to as “updated schedule”) satisfies predetermined constraint conditions. Specifically, at step S409, the ride option generation part 123 determines whether the updated schedule satisfies the constraint of the capacity of the vehicle i. That is, the number of passengers is not allowed to exceed the capacity of the vehicle i at any point of time. The capacity of the vehicle i is identified, referring to, for example, the vehicle information storage part 132.

If the updated schedule satisfies the constraint of the capacity of the vehicle i (YES at step S409), at step S410, the ride option generation part 123 determines whether the difference between the pickup time in the updated schedule and the pickup time provided at the time of reservation and the difference between the drop-off time in the updated schedule and the drop-off time provided at the time of reservation are within a threshold with respect to each user of the updated schedule, in order to prevent a vehicle from not showing up for a long time after the committed time. Specifically, the ride option generation part 123 retrieves records including the schedule ID of the updated schedule from the reservation information storage part 135 (FIG. 7). With respect to each of the retrieved records, the ride option generation part 123 calculates the difference between the pickup time of the record and the departure time at a pickup location with respect to the user ID of the record in the information of the updated schedule (for example, the schedule S₁′ of FIG. 11) and the difference between the drop-off time of the record and the arrival time at a drop-off location with respect to the user ID of the record in the information of the updated schedule. The ride option generation part 123 determines whether the calculated differences are within a threshold. The threshold may be provided in, for example, the terms of use of the transportation service. If the differences are within a threshold with respect to each record (user), it is determined that the constraint is satisfied. If at least one of the differences exceeds a threshold with respect to any record (user), it is determined that the constraint is not satisfied.

If the constraint regarding the pickup time and the drop-off time provided at the time of reservation is satisfied (YES at step S410), at step S411, the ride option generation part 123 determines whether or not the travel time is less than or equal to a maximum value (hereinafter referred to as “maximum travel time”) with respect to a user pertaining to the ride request and other users of the updated schedule, in order to prevent a significant decrease in the service level due to an increase in the travel time in ridesharing. Specifically, the ride option generation part 123 calculates the travel time of each user by subtracting the departure time at a pickup time from the arrival time at a drop-off time with respect to each user ID, referring to the updated schedule (for example, the schedule S₁′ of FIG. 11). The ride option generation part 123 determines whether or not the calculated travel time is less than or equal to the maximum travel time. The maximum travel time may be calculated with reference to a time taken in the case of traveling between a pickup stop location and a drop-off stop location by, for example, the taxi service with respect to each user ID. That is, the maximum travel time may differ from user to user. If the travel time of each user is less than or equal to the maximum travel time, it is determined that the constraint is satisfied. If the travel time of any of the users exceeds the maximum travel time, it is determined that the constraint is not satisfied.

If the constraint regarding the travel time is satisfied (YES at step S411), at step S412, the ride option generation part 123 determines whether the updated schedule conflicts with other existing schedules pertaining to the vehicle i. Specifically, it is determined whether it is possible to ensure an empty travel time between the updated schedule and the existing schedule preceding the updated schedule and/or the existing schedule subsequent to the updated schedule.

If the updated schedule does not conflict with other existing schedules (NO at step S412), at step S413, the ride option generation part 123 generates a ride option that may be provided to the requesting user based on the updated schedule. Specifically, the ride option generation part 123 determines, based on the updated schedule, information such as the service type, pickup location, drop-off location, scheduled pickup time, scheduled drop-off time, and fare of a ride option. Then, the ride option generation part 123 stores the updated schedule in the memory unit 103. For example, in the case of FIG. 11, the information of the schedule S₁′ is stored in the memory unit 103. Because the reservation of the updated schedule is not confirmed at the point of step S413, schedule information regarding the updated schedule is not reflected in the schedule information storage part 134.

On the other hand, if any of the constraints is unsatisfied (NO at step S409, NO at step S410, or NO at step S411) or the updated schedule conflicts with any other existing schedule (YES at step S412), the ride option generation part 123 determines that it is impossible to generate a ride option in the service m with respect to the vehicle i. In this case, the value of the service m is changed and step S402 and the subsequent steps are executed.

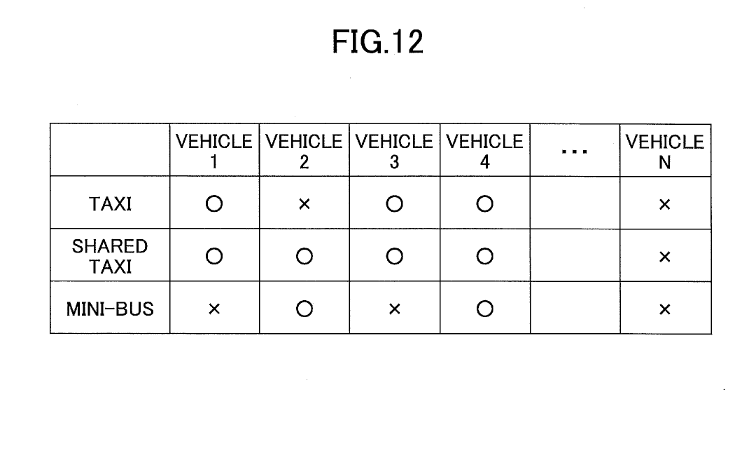

Step S403 and the subsequent steps are executed with respect to each service type with respect to the vehicles 1 through N, so that the information as illustrated in FIG. 12 is obtained.

FIG. 12 is a diagram illustrating information obtained by a process for generating feasible ride options. In FIG. 12, a matrix with three rows and N columns is expressed in a table format. The rows correspond to service types and the columns correspond to vehicles.

The values of the elements of the matrix are a white circle (◯) and a cross (x). The white circle indicates that a ride option pertaining to the service type of the row is feasible with respect to the vehicle of the column. The cross indicates that a ride option pertaining to the service type of the row is not feasible with respect to the vehicle of the column. According to the process of FIG. 9, the schedule information of ride options of “◯” are stored in, for example, the memory unit 103.

Next, a description is given of the details of step S302 of FIG. 8 and the subsequent process. In the following description, a ride option p_{i, m} indicates a ride option pertaining to the service m provided by the vehicle i. Furthermore, a set F indicates the set of ride options stored in the memory unit 103 as feasible ride options by step S301. That is, the set F is the set of ride options corresponding to “◯” in FIG. 12. At step S302 and the subsequent process, a process for selecting a combination of ride options offered to a user at step S203 of FIG. 4 from the set F is executed. In the following description, a combination of ride options offered to a user is referred to as “set A.”

While the set A is one of the elements of the power set of the set F, a user may be confused, that is, finding a desired ride option may become burdensome to a user, if too many ride options are offered to the user. Therefore, an upper limit may be set on the number of ride options to be offered with respect to each service type. For example, one ride option may be offered for each of the taxi service, the shared taxi service, and the mini-bus service. This upper limit is an example of the above-described predetermined condition. The set A is defined as follows:

A⊂F⊂S={p_{i,m}},

where iεN, mεM={taxi,shared,bus}, and N is a set of all vehicles. Here, “taxi,” “shared,” and “bus” indicate the taxi service, the shared taxi service, and the mini-bus service, respectively.

In this embodiment, it is assumed that a user selects a ride option based on the multinominal logit model (MNL). Accordingly, if each of the ride options of the set A is given as an option, the choice probability of each option, Pⱼ, may be calculated by Eq. (1) below:

$${P}_{j} = \frac{exp ( μ {V}_{j} )}{{\sum }_{k ∈ A ⋃ \{ reject \}}^{ } exp ( μ {V}_{k} )} , \qquad ( 1 )$$

where jεA∪{reject}, A is the set of offered ride options, Vⱼ is the utility of an option j, μ is a scale parameter, and k is 1 through the number of options. Here, jεA∪{reject} indicates that an option related to the set A is an element of the union of the ride options making up the set A and no selection of any of the ride options.

Furthermore, in Eq. (1), the set A is one of the subsets of the set F that satisfy a predetermined condition. That is, Eq. (1) is an equation for calculating the choice probability of each of the ride options forming the set A in the case of assuming that the one of the subsets is selected as the set A.

Furthermore, in Eq. (1), Vⱼ is the utility of an option pⱼ. The utility is a concept used in the field of microeconomics and represents the level of satisfaction obtained by selecting an option.

In this embodiment, the option is the ride option p_{i,m}. Accordingly, Pⱼ in Eq. (1) may be replaced by P_{i,m}. Furthermore, Vⱼ may be replaced by utility V_{i,m} obtained by using the ride option p_{i,m}.

The utility V_{i,m} may be calculated by Eq. (2) below:

V_{i,m}=C_{i,m}+Σₖβₖx_{i,m,k}, (2)

where C_{i,m} is an alternative-specific constant, βₖ is a parameter, and x_{i,m,k} is the k^{th} attribute of p_{i,m}.

The k^{th} attribute of the ride option p_{i,m} is, for example, a fare, an access time from an origin to a destination, a waiting time for a ride, a travel time, or an egress time from a drop-off location to a destination. The value of each attribute may be determined or calculated based on the ride option p_{i,m} and the ride request.

Based on the above, at step S302, the choice probability calculation part 124 calculates the choice probability of each ride option p_{i,m} of a subset with respect to each of subsets that satisfy a predetermined condition among the subsets of the set F by the equation obtained by substituting Eq. (2) into Eq. (1).

Next, a description is given of the details of step S303. At step S303, the ride option selection part 125 selects, as the set A, one of the subsets satisfying a predetermined condition that maximizes the expected profit that the provider of ride options obtains from a user pertaining to the ride request (hereinafter simply referred to as “profit”) or the expected utility of a user pertaining to the ride request (hereinafter simply referred to as “utility”).

Here, a variable x_{i,m} that determines whether to offer the ride option p_{i,m} to a user is introduced. If x_{i,m}=1, the ride option p_{i,m} is offered, and if x_{i,m}=0, the ride option p_{i,m} is not offered. With respect to the ride option p_{i,m} that is not feasible, x_{i,m} is always 0. Then, a matrix X that indicates a combination of the ride options p_{i,m} that satisfy a predetermined condition among the subsets of the set F is expressed by Eq. (3) below:

x={x_{i,m}|x_{i,m}ε{0,1}}, (3)

where iεN, mεM={taxi,shared,bus}, and N is a set of all vehicles.

The matrix X is a matrix with three rows and N columns indicating a combination of the ride options p_{i,m} that satisfy a predetermined condition.

For example, the values of a certain X are as follows:

$$x = [ \begin{matrix}10000 … 0 \\ 01000 … 0 \\ 00001 … 0\end{matrix} ] .$$

In the case of having offered a combination of ride options corresponding to a certain X, letting a function that returns the expected profit or the expected utility be R, the problem of selecting the set A that maximizes the expected profit or the expected utility may be formulated by Eq. (4) below:

MaximizeₓR(x). (4)

By offering a user with a combination of ride options corresponding to X that satisfies Eq. (4), it is possible to maximize the expected profit or the expected utility.

Equation (4) may be defined as Eq. (5) as follows:

MaximizeₓR(x)=Σ_{mεM}Σ_{iεN}r_{i,m}*P_{i,m}(x), (5)

where r_{i,m} is the profit or utility obtained from p_{i,m}.

In Eq. (5), P_{i,m} is the choice probability of the ride option p_{i,m} in the case of having offered a combination of ride options corresponding to a certain X, and has been calculated by the choice probability calculation part 124 at step S302.

In the case where r_{i,m} is the profit obtained from the ride option p_{i,m}, r_{i,m} is calculated by Eq. (6) below:

r_{i,m}=f_{i,m}−c_{i,m}, (6)

where f_{i,m} is the fare of p_{i,m} and c_{i,m} is the cost of p_{i,m}.

On the other hand, in the case of maximizing the expected utility, Eq. (5) is rewritten to Eq. (7) below:

$${Maximize}_{x} R ( x ) = \frac{1}{μ} ln ( {\sum }_{m ∈ M}^{ } {\sum }_{i ∈ N}^{ } {x}_{i , m} exp ( μ {V}_{i , m} ) ) . \qquad ( 7 )$$

Based on the above, at step S303, the ride option selection part 125 selects a combination of ride options based on Eq. (6) in the case of giving preference to maximizing the expected profit. On the other hand, in the case of giving preference to maximizing the expected utility, the ride option selection part 125 selects a combination of ride options based on Eq. (7).

Alternatively, a combination of ride options may be selected based on each of Eq. (6) and Eq. (7), and each combination of ride options may be determined as a combination of ride options to be offered to a user.

Furthermore, a combination of ride options to be offered to a user does not have to be limited to a combination of ride options that maximizes the expected profit or the expected utility. For example, the first to N^{th} combinations of ride options in descending order of the expected profit or the expected utility may be determined as combinations of ride options to be offered to a user.

Furthermore, the choice probability, the profit, and the utility may be calculated using equations different from those described above.

As described above, according to the first embodiment, the choice probabilities of the ride options making up a subset are calculated with respect to each of subsets that satisfy a predetermined condition among the subsets of feasible ride options with respect to a transportation service in which ride options of multiple types of forms of ride are provided by a single vehicle. Then, based on the calculated choice probabilities, a combination of ride options is selected, and the selected combination is offered to a user. Accordingly, compared with the case of simply enumerating ride options that are able to satisfy a ride request, it is possible to offer options that are likely to improve economic effects to a user.

Furthermore, according to the first embodiment, in selecting a combination of ride options to be offered to a user, a combination that maximizes the expected profit or the expected utility is selected based on choice probabilities. Accordingly, it is possible to offer to a user a combination of ride options that is desirable in light of the profit of a provider of the transportation service or the utility of a user. As a result, it is possible to expect an increase in the profit of a provider of the transportation service or improvement in the utility of a user.

For example, as a result of optimizing a combination of ride options to be offered to a user as described above, it is possible to make it less likely to offer options that incur a vehicle shortage. Otherwise, a service provider may lose profit because it is difficult to provide services to future users. It is also possible to make it less likely to offer options that will be rejected by a user to prevent the service provider from making a profit.

Next, a description is given of a second embodiment. In the second embodiment, a description is given of differences from the first embodiment. Accordingly, the second embodiment may be the same as the first embodiment with respect to points of which no mention is made in particular.

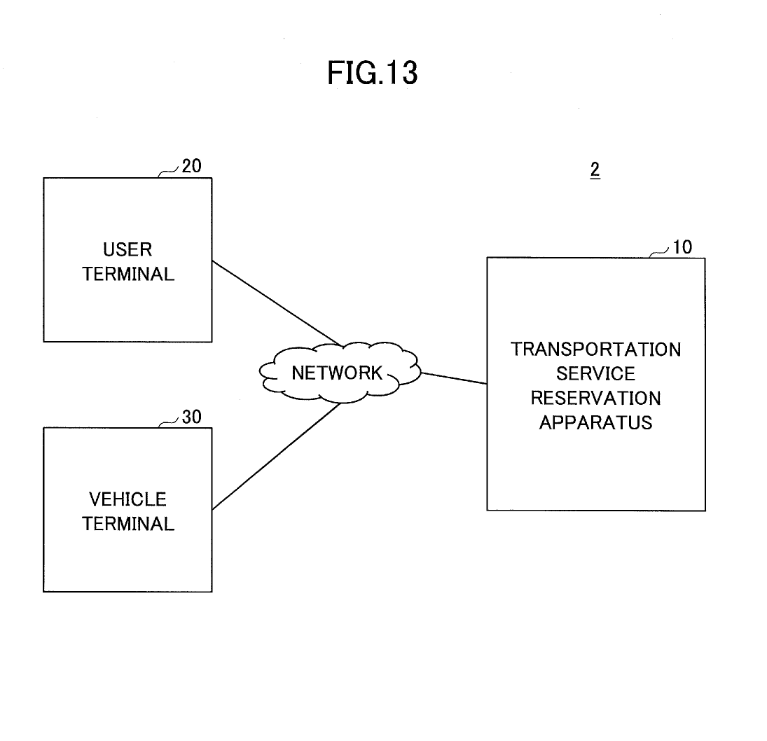

FIG. 13 is a diagram illustrating a configuration of a transportation service reservation system according to the second embodiment. In FIG. 13, the same elements as those of FIG. 1 are referred to by the same reference numerals, and their description is omitted.

Referring to FIG. 13, a transportation service reservation system 2 further includes a vehicle terminal 30. The vehicle terminal 30 is connected to the transportation service reservation apparatus 10 via a communications network such as the Internet or a telephone line so as to be able to communicate with the transportation service reservation apparatus 10. The vehicle terminal 30 is, for example, a dedicated in-vehicle apparatus or a driver's cellular phone. In the case where a person from a service provider (an attendant) rides in a vehicle in addition to the driver, the cellular phone of the attendant may be used as the vehicle terminal 30. In the following description, the “driver” may be replaced with the “attendant.”

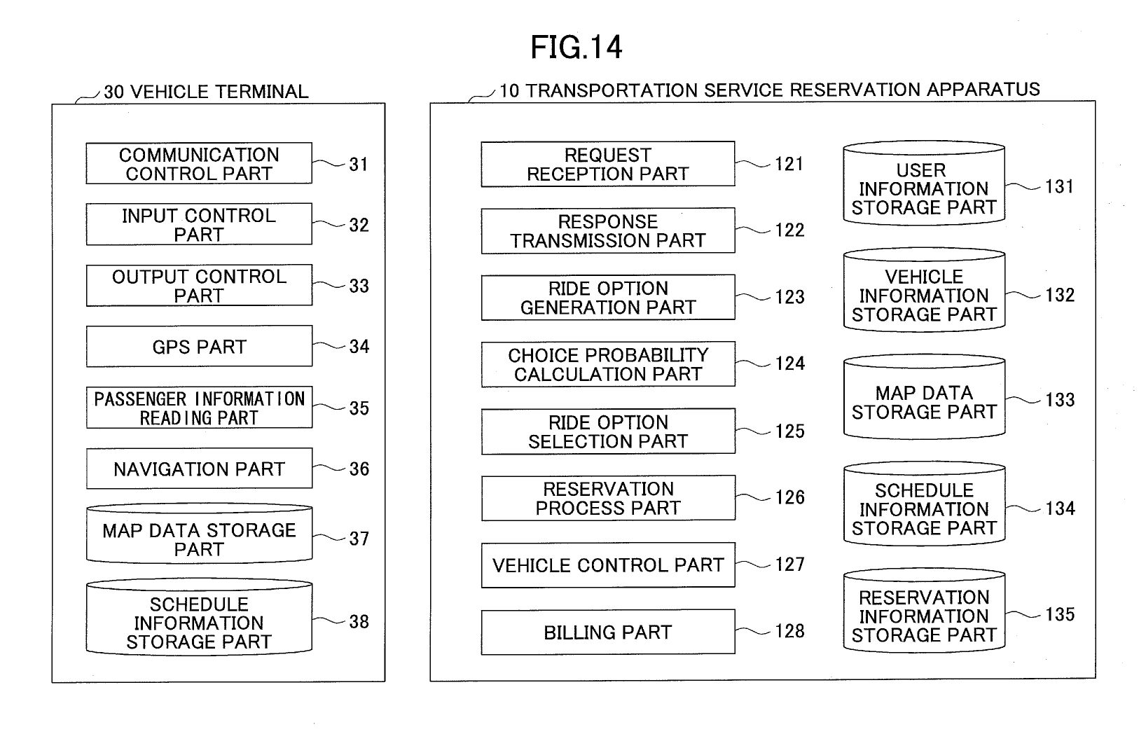

FIG. 14 is a diagram illustrating a functional configuration of a transportation service reservation system according to the second embodiment. In FIG. 14, the same elements as those of FIG. 3 are referred to by the same reference numerals, and their description is omitted. In the second embodiment, the functional configuration of the user terminal 20 may be the same as in the first embodiment. Accordingly, the graphical representation of the user terminal 20 is omitted in FIG. 14.

Referring to FIG. 14, the vehicle terminal 30 includes a communication control part 31, an input control part 32, an output control part 33, a GPS part 34, a passenger information reading part 35, and a navigation part 36. These parts 31 through 36 are implemented by a process that a program installed in the vehicle terminal 30 causes a CPU of the vehicle terminal 30 to execute. The vehicle terminal 30 further includes a map data storage part 37 and a schedule information storage part 38. These storage parts 37 and 38 may be implemented using, for example, a secondary storage unit of the vehicle terminal 30.

The communication control part 31 controls communications with apparatuses such as the transportation service reservation apparatus 10. The input control part 32 receives inputs from the driver. The output control part 33 causes information obtained by a process corresponding to an input to be displayed on a display part of the vehicle terminal 30. The GPS part 34 calculates (determines) the current position of the vehicle based on a GPS signal received by the vehicle terminal 30. The passenger information reading part 35 controls the reading of user information from an IC card (for example, a membership card) possessed by each user. The navigation part 36 performs a route search according to a schedule and providing route guidance with respect to the route retrieved by the route search.

On the other hand, the transportation service reservation apparatus 10 further includes a vehicle control part 127 and a billing part 128. These parts 127 and 128 are implemented by a process that a program installed in the transportation service reservation apparatus 10 causes the CPU 104 to execute.

In the second embodiment, the vehicle control part 127 transmits the schedule information of a ride option pertaining to a reservation request received at step S204 of FIG. 4 to the vehicle terminal 30 of a vehicle to which the ride option is assigned. The schedule information is transmitted subsequently to the execution of step S206 of FIG. 4, for example.

In response to reception of the schedule information, the communication control part 31 of the vehicle terminal 30 of the vehicle stores the received schedule information in the schedule information storage part 38. The output control part 33 may display the schedule information on a display part of the vehicle terminal 30 in response to reception of the schedule information or in response to an input from the driver or in response to the arrival of a time earlier by a predetermined time with respect to the schedule information. This makes it possible for the driver to confirm a drive schedule.

Furthermore, the navigation part 36 of the vehicle terminal 30 may search for a route connecting the stop locations included in the schedule information and provide route guidance. The route search may use map data stored in the map data storage part 37. The vehicle may travel automatically along the route retrieved by the route search. That is, vehicles capable of automatic traveling may be used in the transportation service.

The GPS part 34 determines the current position of the vehicle every time the vehicle travels a predetermined distance or determines the current position of the vehicle at regular time intervals. The GPS part 34 may also determine the current position of the vehicle every time the vehicle travels a predetermined distance and at regular time intervals. The communication control part 31 transmits position information, which is the result of the calculation by the GPS part 34, to the transportation service reservation apparatus 10. The vehicle control part 127 of the transportation service reservation apparatus 10 stores the received position information in the vehicle information storage part 132 in correlation with the identification information of the vehicle that has transmitted the position information. As a result, it is possible for the transportation service reservation apparatus 10 to determine an approximate current position of the vehicle. The ride option generation part 123 may generate a ride option in view of the position information of the vehicle.

The passenger information reading part 35 of the vehicle terminal 30 reads, for example, a user ID from the IC card of a user set on a card reader provided in or connected to the vehicle terminal 30 when the user is picked up and dropped off. The communication control part 31 transmits the read user ID to the transportation service reservation apparatus 10.

The billing part 128 of the transportation service reservation apparatus 10 retrieves a record including the received user ID from the reservation information storage part 135 and charges the amount stored in the item of “fare” of the record. For example, the amount charged may be withdrawn from an account pertaining to the account information stored in correlation with the user ID in the user information storage part 131. Alternatively, a user may be billed for the amount otherwise such as by electronic mail or postal mail.

As described above, according to the second embodiment, it is possible to advance automatization with respect to reservation of a transportation service, control of a vehicle in accordance with the reservation, and billing.

In the above-described embodiments, the schedule information storage part 134 is an example of a storage part, the request reception part 121 is an example of a reception part, the ride option generation part 123 is an example of a generation part, the choice probability calculation part 124 is an example of a calculation part, and the ride option selection part 125 is an example of a selection part.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A transportation service reservation method, comprising:
receiving a ride request specifying an origin and a destination;
with respect to each of vehicles each capable of providing ride options in multiple forms of ride, generating a feasible ride option pertaining to the multiple forms of ride by referring to a storage part storing information indicating schedules assigned to the vehicle and forms of ride of the schedules;
calculating a choice probability of each of ride options forming a subset with respect to each of one or more subsets satisfying a predetermined condition among subsets of a group of the generated feasible ride options; and
selecting a subset to be offered in response to the ride request from among the one or more subsets satisfying the predetermined condition, based on the calculated choice probabilities,
wherein said receiving, said generating, said calculating, and said selecting are executed by a computer processor.

2. The transportation service reservation method as claimed in claim 1, wherein the multiple forms of ride differ from each other in the number of ride requests that are simultaneously served.

3. The transportation service reservation method as claimed in claim 1, wherein the multiple forms of ride differ from each other in flexibility of a route.

4. The transportation service reservation method as claimed in claim 1, wherein in said selecting, an expected profit of a provider of the ride options is calculated with respect to each of the one or more subsets satisfying the predetermined condition based on the calculated choice probabilities and the subset to be offered in response to the ride request is selected based on the expected profit.

5. The transportation service reservation method as claimed in claim 1, wherein in said selecting, an expected utility of a user of the ride options is calculated with respect to each of the one or more subsets satisfying the predetermined condition based on the calculated choice probabilities and the subset to be offered in response to the ride request is selected based on the expected utility.

6. The transportation service reservation method as claimed in claim 1, further comprising:
returning the subset selected in said selecting to a transmitter of the ride request;
receiving one of the ride options selected from the returned subset by a user; and
transmitting information regarding a schedule that realizes the selected ride option to one of the vehicles pertaining to the selected ride option,
wherein said returning, said receiving, and said transmitting are executed by the computer.

7. A transportation service reservation apparatus, comprising:
a storage part configured to store, with respect to each of vehicles each capable of providing ride options in multiple forms of ride, information indicating schedules assigned to the vehicle and forms of ride of the schedules;
a processor; and
a memory storing instructions that, when executed by the processor, cause the transportation service reservation apparatus to
receive a ride request specifying an origin and a destination;
generate a feasible ride option pertaining to the multiple forms of ride with respect to each of the vehicles by referring to the storage part;
calculate a choice probability of each of ride options forming a subset with respect to each of one or more subsets satisfying a predetermined condition among subsets of a group of the generated feasible ride options; and
select a subset to be offered in response to the ride request from among the one or more subsets satisfying the predetermined condition, based on the calculated choice probabilities.

8. The transportation service reservation apparatus as claimed in claim 7, wherein the multiple forms of ride differ from each other in the number of ride requests that are simultaneously served.

9. The transportation service reservation apparatus as claimed in claim 7, wherein the multiple forms of ride differ from each other in flexibility of a route.

10. The transportation service reservation apparatus as claimed in claim 7, wherein the memory stores instructions that, when executed by the processor, cause the transportation service reservation apparatus to calculate an expected profit of a provider of the ride options with respect to each of the one or more subsets satisfying the predetermined condition based on the calculated choice probabilities and select the subset to be offered in response to the ride request based on the expected profit.

11. The transportation service reservation apparatus as claimed in claim 7, wherein the memory stores instructions that, when executed by the processor, cause the transportation service reservation apparatus to calculate an expected utility of a user of the ride options with respect to each of the one or more subsets satisfying the predetermined condition based on the calculated choice probabilities and select the subset to be offered in response to the ride request based on the expected utility.

12. The transportation service reservation apparatus as claimed in claim 7, wherein the memory stores instructions that, when executed by the processor, cause the transportation service reservation apparatus to
return the subset selected in said selecting to a transmitter of the ride request;
receive one of the ride options selected from the returned subset by a user; and
transmit information regarding a schedule that realizes the selected ride option to one of the vehicles pertaining to the selected ride option.

13. A non-transitory computer-readable recording medium having stored therein a program for causing a computer to execute a transportation service reservation process, the transportation service reservation process comprising:
receiving a ride request specifying an origin and a destination;
with respect to each of vehicles each capable of providing ride options in multiple forms of ride, generating a feasible ride option pertaining to the multiple forms of ride by referring to a storage part storing information indicating schedules assigned to the vehicle and forms of ride of the schedules;
calculating a choice probability of each of ride options forming a subset with respect to each of one or more subsets satisfying a predetermined condition among subsets of a group of the generated feasible ride options; and
selecting a subset to be offered in response to the ride request from among the one or more subsets satisfying the predetermined condition, based on the calculated choice probabilities.

14. The non-transitory computer-readable recording medium as claimed in claim 13, wherein the multiple forms of ride differ from each other in the number of ride requests that are simultaneously served.

15. The non-transitory computer-readable recording medium as claimed in claim 13, wherein the multiple forms of ride differ from each other in flexibility of a route.

16. The non-transitory computer-readable recording medium as claimed in claim 13, wherein in said selecting, an expected profit of a provider of the ride options is calculated with respect to each of the one or more subsets satisfying the predetermined condition based on the calculated choice probabilities and the subset to be offered in response to the ride request is selected based on the expected profit.

17. The non-transitory computer-readable recording medium as claimed in claim 13, wherein in said selecting, an expected utility of a user of the ride options is calculated with respect to each of the one or more subsets satisfying the predetermined condition based on the calculated choice probabilities and the subset to be offered in response to the ride request is selected based on the expected utility.

18. The non-transitory computer-readable recording medium as claimed in claim 13, wherein the transportation service reservation process further comprises:
returning the subset selected in said selecting to a transmitter of the ride request;
receiving one of the ride options selected from the returned subset by a user; and
transmitting information regarding a schedule that realizes the selected ride option to one of the vehicles pertaining to the selected ride option.
